(19) United States
(12) Patent Application Publication
(10) Pub. No.: US 2026/0274700 A1
(43) Pub. Date: Sep. 17, 2026

(54) NEGATIVE ELECTRODE ACTIVE MATERIAL FOR CHLORIDE ION BATTERY, METHOD FOR PRODUCING SAME, AND CHLORIDE ION BATTERY

(71) Applicant: TOYOTA JIDOSHA KABUSHIKI KAISHA, Toyota-shi (JP)

(72) Inventor: Hidenori MIKI, Hiratsuka-shi (JP)

(73) Assignee: TOYOTA JIDOSHA KABUSHIKI KAISHA, Toyota-shi (JP)

(21) Appl. No.: 19/562,970

(22) Filed: Mar. 11, 2026

(30) Foreign Application Priority Data
Mar. 13, 2025 (JP) 2025-040339

(51) Int. Cl. C01F 7/56; H01M 4/02; H01M 4/58; H01M 10/054

(52) U.S. Cl. CPC C01F 7/56; H01M 4/582; H01M 10/054; C01P 2002/72; C01P 2006/40; H01M 2004/027

(57) ABSTRACT

The present disclosure provides a negative electrode active material for a chloride ion battery that is capable of improving the initial charge-discharge efficiency of a chloride ion battery, a method for producing the same, and a chloride ion battery containing such a negative electrode active material for a chloride ion battery. The negative electrode active material for a chloride ion battery of the present disclosure contains a chloroaluminate of an alkali metal. The method of the present disclosure for producing a negative electrode active material for a chloride ion battery includes treating an alkali metal chloride and aluminum chloride by a mechanical milling method. a chloride ion battery 1 of the present disclosure includes a negative electrode active material layer 20, and the negative electrode active material layer contains the negative electrode active material for a chloride ion battery of the present disclosure.

### TECHNICAL FIELD

The present disclosure relates to a negative electrode active material for a chloride ion battery, a method for producing the same, and a chloride ion battery.

### BACKGROUND

As disclosed in PTLs 1 and 2, chloride ion batteries and various materials that constitute the chloride ion batteries have been developed.

### CITATION LIST

### Patent Literature

[PTL 1] Japanese Unexamined Patent Publication (Kokai) No. 2022-126132
[PTL 2] Japanese Unexamined Patent Publication (Kokai) No. 2022-126133

### SUMMARY

### Technical Problem

There is room for improvement in the initial charge-discharge efficiency of chloride ion batteries.

An object of the present disclosure is to provide a negative electrode active material for a chloride ion battery that is capable of improving the initial charge-discharge efficiency of a chloride ion battery, a method for producing the same, and a chloride ion battery containing such a negative electrode active material for a chloride ion battery.

The present inventors have found that the above-mentioned problem can be solved by the following solution.

### <Aspect 1>

A negative electrode active material for a chloride ion battery, the negative electrode active material containing a chloroaluminate of an alkali metal.

### <Aspect 2>

The negative electrode active material for a chloride ion battery according to aspect 1,
wherein the alkali metal is sodium, potassium, or lithium, and
wherein the chloroaluminate is a tetrachloroaluminate.

### <Aspect 3>

A chloride ion battery, including a negative electrode active material layer, wherein
the negative electrode active material layer contains the negative electrode active material for a chloride ion battery according to aspect 1 or 2.

### <Aspect 4>

A method for producing the negative electrode active material for a chloride ion battery according to aspect 1 or 2, the method including treating an alkali metal chloride and aluminum chloride by a mechanical milling method.

### <Aspect 5>

The method according to aspect 4, wherein a molar ratio of the alkali metal chloride to the aluminum chloride is from 0.20:0.80 to 0.80:0.20.

### Advantageous Effects of Invention

According to the present disclosure, it is possible to provide a negative electrode active material for a chloride ion battery that is capable of improving the initial charge-discharge efficiency of a chloride ion battery, a method for producing the same, and a chloride ion battery containing such a negative electrode active material for a chloride ion battery.

### BRIEF DESCRIPTION OF DRAWINGS

FIG. 1 is a schematic cross-sectional view illustrating an example of a chloride ion battery of the present disclosure;

FIG. 2 presents XRD patterns of materials for negative electrode active materials of Examples 1 to 4, as well as NaCl, AlCl₃, and NaAlCl₄;

FIG. 3 presents a charge-discharge curve of a chloride ion battery of Example 1;

FIG. 4 presents a charge-discharge curve of a chloride ion battery of Example 2;

FIG. 5 presents a charge-discharge curve of a chloride ion battery of Example 3;

FIG. 6 presents a charge-discharge curve of a chloride ion battery of Example 4;

FIG. 7 presents a charge-discharge curve of a chloride ion battery of Example 5;

FIG. 8 presents a charge-discharge curve of a chloride ion battery of Example 6;

FIG. 9 presents a charge-discharge curve of a chloride ion battery of Example 7;

FIG. 10 presents a charge-discharge curve of a chloride ion battery of Reference Example; and

FIG. 11 presents XRD patterns of a material for a negative electrode active material of Example 5 at the initial stage (before charging and discharging), after charging (−2.0 V), and after discharging (0 V).

### DESCRIPTION OF EMBODIMENTS

Hereinafter, embodiments of the present disclosure will be described in detail. However, it should be noted that the present disclosure is not limited to the following embodiments, and can be variously modified within the scope thereof.

### <<Negative Electrode Active Material for Chloride Ion Battery>>

The negative electrode active material for a chloride ion battery of the present disclosure contains a chloroaluminate of an alkali metal.

The present inventors have conceived of using aluminum chloride (AlCl₃), which is a chloride of aluminum (Al) having a relatively low standard oxidation-reduction potential, as a negative electrode active material for a chloride ion battery. The present inventors have confirmed that a chloride ion battery containing AlCl₃ as a negative electrode active material is capable of operation, but believe that there is room for further improvement from the viewpoint of initial charge-discharge efficiency.

In this regard, the present inventors have found that a negative electrode active material for a chloride ion battery containing a chloroaluminate of an alkali metal can improve the initial charge-discharge efficiency of a battery containing the negative electrode active material. The reason therefor is not intended to be bound by any theory, but is presumed to be as follows.

Firstly, it is believed that the negative electrode active material for a chloride ion battery of the present disclosure has a lowered melting point because at least parts of the alkali metal and Al are solid-solved. Therefore, it is believed that the negative electrode active material of the present disclosure has improved ion conductivity, and thus can improve the initial charge-discharge efficiency of a battery.

Secondly, it is believed that the chloroaluminate of the alkali metal is phase-separated into an alkali metal chloride and Al along with charge and discharge. It appears that the phase separation makes the negative electrode active material finer, and chloride ions are likely to diffuse not only on the surface of Al but also into the inside thereof, i.e., chlorination of the negative electrode active material during discharging is likely to proceed, and therefore, the negative electrode active material can improve the initial charge-discharge efficiency of a battery.

In the negative electrode active material for a chloride ion battery of the present disclosure, the alkali metal may be sodium, potassium, or lithium, and the chloroaluminate may be a tetrachloroaluminate. Specifically, the negative electrode active material for a chloride ion battery of the present disclosure may be sodium tetrachloroaluminate (NaAlCl₄), potassium tetrachloroaluminate (KAlCl₄), or lithium tetrachloroaluminate (LiAlCl₄). Thus, the negative electrode active material for a chloride ion battery can effectively improve the initial charge-discharge efficiency of a battery.

In a chloride ion battery, the negative electrode active material is usually dechlorinated during charging and chlorinated during discharging.

The negative electrode active material for a chloride ion battery of the present disclosure can be produced by a production method described later.

As the negative electrode active material for a chloride ion battery of the present disclosure, a commercially available product may be used.

### <<Method for Producing Negative Electrode Active Material for Chloride Ion Battery>>

The method of the present disclosure for producing a negative electrode active material for a chloride ion battery includes treating an alkali metal chloride and aluminum chloride by a mechanical milling method.

The method of treating the alkali metal chloride and aluminum chloride by the mechanical milling method is not particularly limited, and examples thereof include a method of mixing the components using a ball milling machine. The ball milling machine may be operated by any of planetary, vibration, rotation, and other systems.

The number of revolutions of the base plate of the ball milling machine is not particularly limited, and may be, for example, 300 rpm or more, 400 rpm or more, 500 rpm or more, or 600 rpm or more, and 1000 rpm or less, 900 rpm or less, 800 rpm or less, 700 rpm or less, or 600 rpm or less.

The mixing time by the ball milling machine is not particularly limited, and may be, for example, 0.5 hours or more, 1 hour or more, 2 hours or more, or 3 hours or more, and 10 hours or less, 8 hours or less, 6 hours or less, 4 hours or less, or 3 hours or less.

In the method of the present disclosure, the molar ratio of the alkali metal chloride to aluminum chloride may be from 0.10:0.90 to 0.90:0.10, from 0.20:0.80 to 0.80:0.20, or from 0.40:0.60 to 60:40. The negative electrode active material for a chloride ion battery thus produced can effectively improve the initial charge-discharge efficiency of a battery.

The amount of the alkali metal chloride used may be from 20 mol % to 90 mol %, from 35 mol % to 80 mol %, or from 50 mol % to 75 mol %. The amount of the alkali metal chloride used may be more than 0 mol %, 10 mol % or more, 20 mol % or more, 30 mol % or more, 35 mol % or more, 40 mol % or more, 50 mol % or more, 60 mol % or more, 70 mol % or more, or 75 mol % or more, and less than 100 mol %, 90 mol % or less, 80 mol % or less, less than 75 mol %, 75 mol % or less, 70 mol % or less, 65 mol % or less, 60 mol % or less, 55 mol % or less, or 50 mol % or less. The negative electrode active material for a chloride ion battery thus produced can effectively improve the initial charge-discharge efficiency of a battery.

From the viewpoint of inhibiting the by-production of an alkali metal chloride, the amount of the alkali metal chloride used may be less than 75 mol %, 70 mol % or less, 65 mol % or less, 60 mol % or less, 55 mol % or less, or 50 mol % or less.

The amount of aluminum chloride used may be from 10 mol % to 80 mol %, from 20 mol % to 65 mol %, or from 25 mol % to 50 mol %. The amount of aluminum chloride used may be more than 0 mol %, 10 mol % or more, 20 mol % or more, 25 mol % or more, 30 mol % or more, 40 mol % or more, or 50 mol % or more, and less than 100 mol %, 90 mol % or less, 80 mol % or less, 70 mol % or less, 65 mol % or less, 60 mol % or less, 50 mol % or less, 40 mol % or less, 30 mol % or less, or 25 mol % or less. The negative electrode active material for a chloride ion battery thus produced can effectively improve the initial charge-discharge efficiency of a battery.

From the viewpoint of inhibiting the by-production of AlCl₃, the amount of aluminum chloride used may be 60 mol % or less, 55 mol % or less, or 50 mol % or less.

### <<Negative Electrode Mixture for Chloride Ion Battery>>

The negative electrode mixture for a chloride ion battery contains the negative electrode active material for a chloride ion battery of the present disclosure. The negative electrode mixture for a chloride ion battery may optionally contain a solid electrolyte, a conductive additive, a binder, and the like.

In the present disclosure, the “negative electrode mixture” means a composition that can constitute a negative electrode active material layer as it is or with the further addition of other components.

Hereinafter, elements that can constitute the negative electrode mixture for a chloride ion battery will be described.

### <Negative Electrode Active Material>

The negative electrode mixture for a chloride ion battery contains the negative electrode active material for a chloride ion battery of the present disclosure. As for the negative electrode active material for a chloride ion battery of the present disclosure, the above description can be referred to.

The negative electrode mixture may contain a negative electrode active material other than the negative electrode active material of the present disclosure, but does not have to contain such a negative electrode active material. The negative electrode active material other than the negative electrode active material of the present disclosure is not particularly limited, as long as it has a lower potential than that of a positive electrode active material. Examples of such a negative electrode active material include elemental metals such as lead (Pb) and tin (Sn), alloys, oxides containing the elemental metal, and chlorides containing the elemental metal.

Specifically, the negative electrode active material may be, for example, CsSnCl₃, or CsSnCl₃ doped with yttrium (Y), i.e., CsSn₁₋ₓYₓCl₃₊ₓ (0<x≤0.1).

CsSnCl₃ can be produced, for example, by applying mechanical impact to cesium chloride (CsCl) and tin chloride (SnCl₂) at a predetermined molar ratio. Examples of such a method include a mechanical milling method. Specifically, a method of mixing the raw materials using a ball milling machine can be mentioned. The ball milling machine may be operated by any of planetary, vibration, rotation, and other systems. Use of a planetary ball milling machine enables efficient mixing of a sample. This process may be performed in an inert gas atmosphere.

When the sample is mixed using a planetary ball milling machine, the number of revolutions of the base plate is not particularly limited, and may be, for example, 100 rpm or more, 200 rpm or more, 300 rpm or more, 400 rpm or more, 500 rpm or more, or 600 rpm or more, and 1000 rpm or less, 900 rpm or less, 800 rpm or less, 700 rpm or less, or 600 rpm or less.

When the sample is mixed using a planetary ball milling machine, the mixing time is not particularly limited, and may be 1 hour or more, 3 hours or more, 5 hours or more, or 10 hours or more, and 30 hours or less, 20 hours or less, 15 hours or less, or 10 hours or less.

The shape, size, and the like of the negative electrode active material are not particularly limited, as long as the negative electrode active material can function as a negative electrode active material of a chloride ion battery.

The content of the negative electrode active material in the negative electrode mixture is not particularly limited, and can be appropriately set in consideration of the desired capacity of the battery and the like.

### <Solid Electrolyte>

The negative electrode mixture may contain a solid electrolyte. The solid electrolyte assists chloride ion conduction.

The solid electrolyte is not particularly limited, and may be, for example, at least one selected from tin chloride (SnCl₂), strontium chloride (SrCl₂), barium chloride (BaCl₂), and the like.

The solid electrolyte may be the above-mentioned chloride doped with potassium (K), and may be, for example, Sr₁₋ₓKₓC₂₋ₓ (0<x≤0.1).

Sr₁₋ₓKₓC₂₋ₓ (0<x≤0.1) can be produced, for example, by applying mechanical impact to strontium chloride (SrCl₂) and potassium chloride (KCl) at a predetermined molar ratio. Examples of such a method include a mechanical milling method. Specifically, a method of mixing the raw materials using a ball milling machine can be mentioned. The ball milling machine may be operated by any of planetary, vibration, rotation, and other systems. Use of a planetary ball milling machine enables efficient mixing of a sample. This process may be performed in an inert gas atmosphere.

When the raw materials are mixed using a planetary ball milling machine, the number of revolutions of the base plate is not particularly limited, and may be, for example, 300 rpm or more, 400 rpm or more, 500 rpm or more, or 600 rpm or more, and 1000 rpm or less, 900 rpm or less, 800 rpm or less, 700 rpm or less, or 600 rpm or less.

When the raw materials are mixed using a planetary ball milling machine, the mixing time is not particularly limited, and may be, for example, 0.5 hours or more, 1 hour or more, 2 hours or more, or 3 hours or more, and 10 hours or less, 8 hours or less, 6 hours or less, 4 hours or less, or 3 hours or less.

The shape, size, and the like of the solid electrolyte are not particularly limited, as long as the solid electrolyte can function as a solid electrolyte of a chloride ion battery.

The content of the solid electrolyte in the negative electrode mixture can be appropriately set in consideration of the desired ion conductivity and the like.

### <Conductive Additive>

The negative electrode mixture may contain a conductive additive. The conductive additive is not particularly limited, as long as it has electron conductivity.

The conductive additive may be, for example, a carbon material, an elemental metal, or a metal compound, or a combination thereof.

The carbon material may be at least one selected from, for example, carbon black such as acetylene black, Ketjen black, and furnace black, graphite powder, and fibrous carbon materials such as vapor grown carbon fiber (VGCF).

The content of the conductive additive in the negative electrode mixture is not particularly limited, and can be appropriately set in consideration of the desired electron conductivity and the like.

### <Binder>

The binder is not particularly limited, as long as it can be used as a binder for a chloride ion battery.

The content of the binder in the negative electrode mixture is not particularly limited, and can be appropriately set in consideration of the desired binding property and the like.

### <Other Components>

The negative electrode mixture may contain a component other than those described above, but does not have to contain such a component. The type, content, and the like of such a component can be appropriately set.

### <<Chloride Ion Battery>>

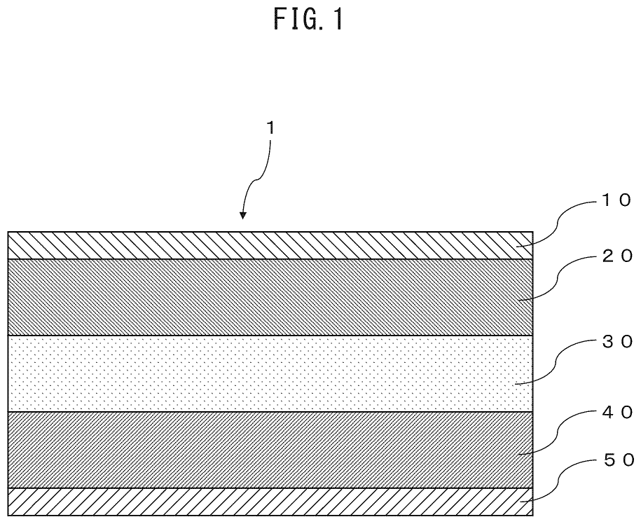

As illustrated in FIG. 1, a chloride ion battery 1 of the present disclosure includes a negative electrode active material layer 20, and the negative electrode active material layer contains the negative electrode active material for a chloride ion battery of the present disclosure. The chloride ion battery of the present disclosure has improved initial charge-discharge efficiency because it contains the negative electrode active material for a chloride ion battery of the present disclosure.

As illustrated in FIG. 1, the chloride ion battery 1 of the present disclosure may include the negative electrode active material layer 20, an electrolyte layer 30, and a positive electrode active material layer 40 in this order.

The chloride ion battery of the present disclosure may be a liquid-type battery or a solid-state battery, and may be particularly a solid-state battery. In the present disclosure, the “solid-state battery” means a battery containing at least a solid electrolyte as an electrolyte, and therefore the solid-state battery may contain, as an electrolyte, a combination of a solid electrolyte and a liquid electrolyte. The solid-state battery of the present disclosure may be an all-solid-state battery, i.e., a battery containing, as an electrolyte, only a solid electrolyte.

The chloride ion battery may be a primary battery or a secondary battery, and may be particularly a secondary battery.

The shape of the chloride ion battery may be, for example, a coin shape, a laminate shape (pouch shape), a cylindrical shape, or a square shape.

The chloride ion battery can be produced, for example, by forming the above-mentioned layers according to a dry method or a wet method.

The chloride ion battery of the present disclosure can be suitably used in at least one vehicle selected from, for example, a hybrid electric vehicle (HEV), a plug-in hybrid electric vehicle (PHEV), and a battery electric vehicle (BEV).

Hereinafter, elements that can constitute the chloride ion battery of the present disclosure will be described. In particular, a case wherein the battery of the present disclosure is an all-solid-state chloride ion secondary battery will be described as an example.

### <Negative Electrode Active Material Layer>

The negative electrode active material layer contains the negative electrode active material for a chloride ion battery of the present disclosure. As for the negative electrode active material for a chloride ion battery of the present disclosure, the above description can be referred to.

The negative electrode active material layer may be a green compact of a negative electrode mixture containing the negative electrode active material for a chloride ion battery of the present disclosure. As for the negative electrode mixture, the above description can be referred to.

### <Electrolyte Layer>

The electrolyte layer may be a solid electrolyte layer containing a solid electrolyte. The solid electrolyte layer may optionally contain a binder.

### (Solid Electrolyte and Binder)

As for the solid electrolyte and the binder, the above description can be referred to.

### <Positive Electrode Active Material Layer>

The positive electrode active material layer contains a positive electrode active material, and may optionally contain a solid electrolyte, a conductive additive, a binder, and the like.

### (Positive Electrode Active Material)

The positive electrode active material is usually chlorinated during charging and dechlorinated during discharging. The positive electrode active material is not particularly limited, as long as it has a higher potential than that of a negative electrode active material. The positive electrode active material may be, for example, a metal chloride. The metal chloride is not particularly limited, and may be a material known as a positive electrode active material for a chloride ion battery, such as a chloride of a poor metal, such as bismuth chloride (BiCl₃), gallium chloride (GaCl₃), or indium chloride (InCl₃); a chloride of a noble metal, such as copper chloride (CuCl) or silver chloride (AgCl); a chloride of an iron group element, such as nickel chloride (NiCl₂), cobalt chloride (CoCl₂), or iron chloride (FeCl₂); or vanadium chloride (VCl₃).

The shape, size, and the like of the positive electrode active material are not particularly limited, as long as the positive electrode active material can function as a positive electrode active material of a chloride ion battery.

The content of the positive electrode active material in the positive electrode active material layer is not particularly limited, and can be appropriately set in consideration of the desired capacity of the battery and the like.

### (Solid Electrolyte, Conductive Additive, and Binder)

As for the solid electrolyte, the conductive additive, and the binder, the above description can be referred to.

### <Other Configurations>

As illustrated in FIG. 1, the chloride ion battery 1 of the present disclosure may further include a negative electrode current collector layer 10 and a positive electrode current collector layer 50.

The shape of each of the layers that can constitute the battery is not particularly limited, and may be, for example, a sheet shape having a substantially flat surface.

The thickness of each of the layers that can constitute the battery is not particularly limited, and can be appropriately adjusted according to the configuration of the battery.

The chloride ion battery of the present disclosure may further have a configuration other than those described above.

### EXAMPLES

### Example 1

### <Synthesis of Negative Electrode Active Material for Chloride Ion Battery>

As raw materials, 10 mg in total of sodium chloride (NaCl) and aluminum chloride (AlCl₃) were weighed so that the molar ratio of NaCl:AlCl₃ might be 0.20:0.80. These raw materials were mixed using a ball mill at 600 rpm for 3 hours. Thus, a material for a negative electrode active material of Example 1 was obtained.

### <Production of Chloride Ion Battery>

The obtained material for a negative electrode active material, potassium (K)-doped SrCl₂ (Sr_{0.97}K_{0.03}Cl_{1.97}) as a solid electrolyte, and vapor grown carbon fiber (VGCF) (manufactured by Showa Denko K. K.) as a conductive additive were weighed so that the mass ratio of the material for a negative electrode active material:the solid electrolyte:the conductive additive might be 30:60:10. The materials were mixed using a ball mill at 100 rpm for 10 hours to produce a negative electrode mixture. The negative electrode mixture was subjected to powder compacting to produce a negative electrode active material layer as a working electrode.

Sr_{0.97}K_{0.03}Cl_{1.97} as a solid electrolyte was synthesized by mixing strontium chloride (SrCl₂) and potassium chloride (KCl) using a ball mill at 600 rpm for 3 hours.

The solid electrolyte layer was formed by subjecting 100 mg of Sr_{0.97}K_{0.03}Cl_{1.97} as a solid electrolyte to powder compacting.

On one side of a layer formed using CsSnCl₃, a Sn foil was placed to produce a counter electrode. CsSnCl₃ was synthesized by weighing cesium chloride (CsCl) and tin chloride (SnCl₂) at a predetermined molar ratio and mechanically milling the components using a ball mill at 600 rpm for 10 hours.

The working electrode, the solid electrolyte layer, and the counter electrode were stacked in this order to produce an all-solid-state chloride ion battery. The solid electrolyte layer and the counter electrode were stacked so that the solid electrolyte layer and the CsSnCl₃ layer of the counter electrode might face each other.

### Examples 2 to 4

Materials for negative electrode active materials and batteries of Examples 2 to 4 were obtained in the same manner as in Example 1, except that the molar ratio of NaCl to AlCl₃ was changed as shown in Table 1.

### Example 5

A material for a negative electrode active material and a battery of Example 5 were obtained in the same manner as in Example 3, except that the number of revolutions of the ball mill at the time of production of the negative electrode mixture was changed to 300 rpm.

### Example 6

A material for a negative electrode active material and a battery of Example 6 were obtained in the same manner as in Example 5, except that lithium chloride (LiCl) was used instead of NaCl.

### Example 7

A material for a negative electrode active material and a battery of Example 7 were obtained in the same manner as in Example 5, except that potassium chloride (KCl) was used instead of NaCl.

### Reference Example

A battery of Reference Example was obtained in the same manner as in Example 1, except that AlCl₃ was used as the negative electrode active material.

### <<Evaluation>>

### <XRD Measurement>

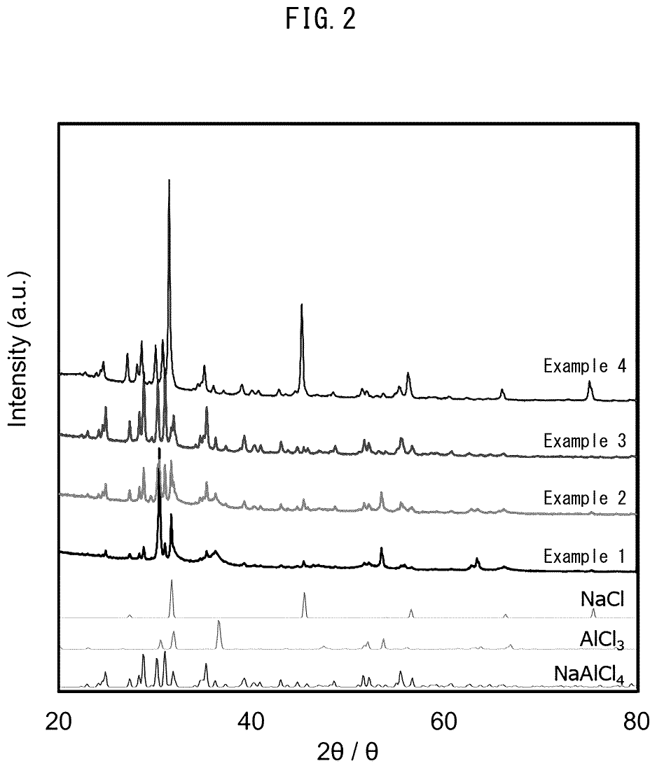

In a discharged state before the operation of the battery, the materials for negative electrode active materials of Examples 1 to 4 were subjected to X-ray diffraction (XRD) measurement. The XRD measurement was performed using Ultima IV manufactured by Rigaku Corporation as an X-ray diffractometer by parafocusing of emitting CuKα radiation under conditions of a tube voltage of 40 kV and a tube current of 40 mA in an inert gas atmosphere. The sample was sealed in an airtight sample stage in an argon atmosphere, and the measurement was performed without exposure to the air. A glass sample holder was used as a substrate on which the sample was mounted. The obtained XRD patterns are presented in FIG. 2.

As can be seen from FIG. 2, in all of Examples 1 to 4, NaAlCl₄ as a negative electrode active material was produced. In particular, in Example 3, a monolayer of NaAlCl₄ was produced. In contrast, in Examples 1 and 2, AlCl₃ was by-produced. This is presumably because the amount of AlCl₃ as a raw material was excessive in Examples 1 and 2. In addition, in Example 4, NaCl was by-produced. This is presumably because the amount of NaCl as a raw material was excessive in Example 4.

### <Charge-Discharge Test>

The battery of each of the examples was charged and discharged as described below at a test temperature of 140° C. and a current density of 0.03 mA/cm² while a sealed vessel containing the battery was evacuated.

Specifically, for the batteries of Examples 1 to 4, constant current (CC) charging was performed with the end-of-charge voltage set to −2.0 V. Then, CC discharging was performed with the end-of-discharge voltage set to 0 V.

For the battery of Example 5, CC charging was performed with the end-of-charge voltage set to −2.0 V. Then, CC discharging was performed with the end-of-discharge voltage set to 1.0 V.

For the batteries of Examples 6 and 7, constant current-constant voltage (CCCV) charging was performed with the end-of-charge voltage set to −2.0 V. Then, CCCV discharging was performed with the end-of-discharge voltage set to 1.0 V.

For the battery of Reference Example, CC charging was performed with the end-of-charge voltage set to −2.0 V. Then, CC discharging was performed with the end-of-discharge voltage set to 0.5 V.

For the charge-discharge test, an electrochemical measurement system equipped with a frequency response analyzer (VMP-300 high-performance electrochemical measurement system, manufactured by BioLogic Science Instruments SAS) was used.

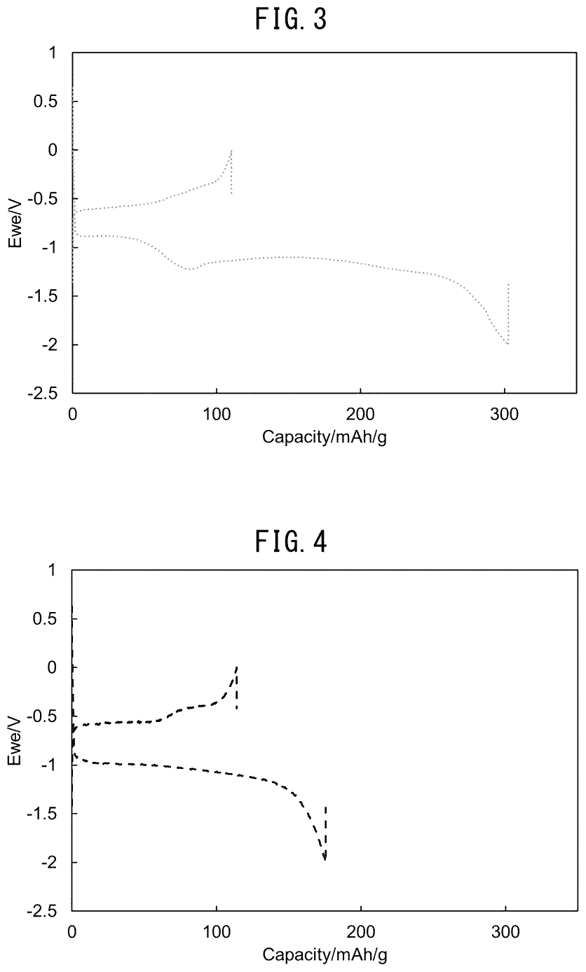

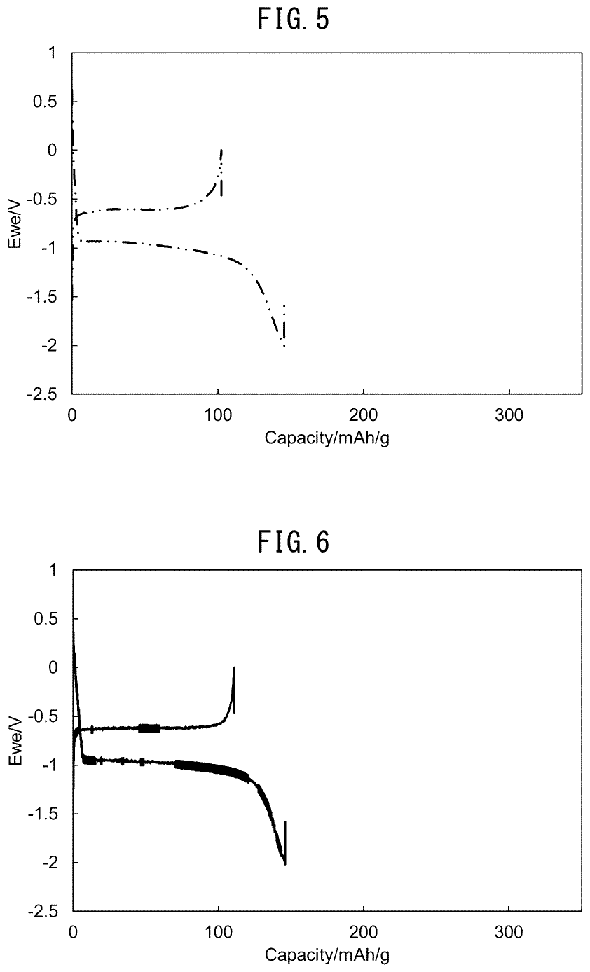

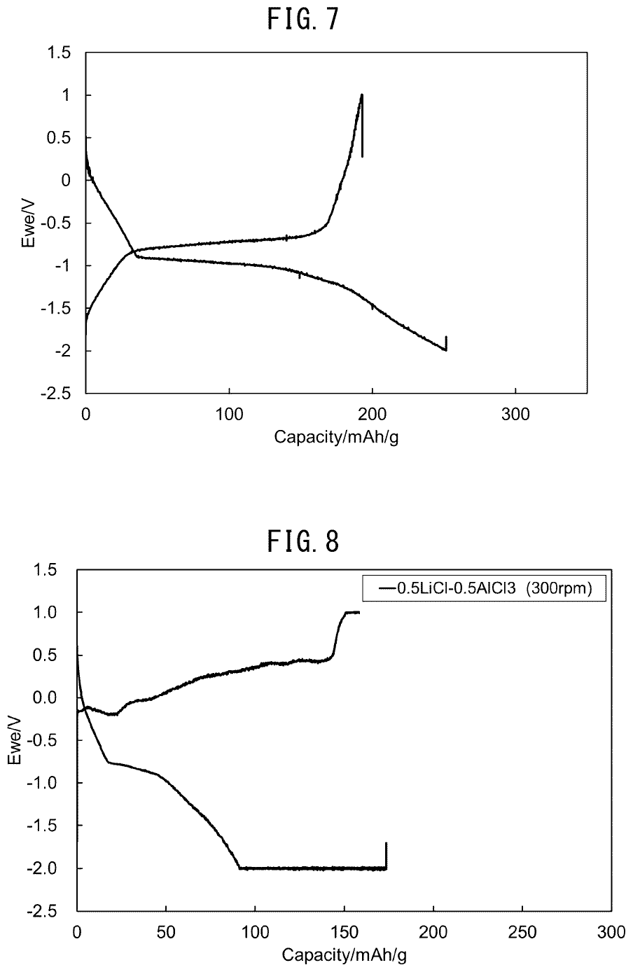

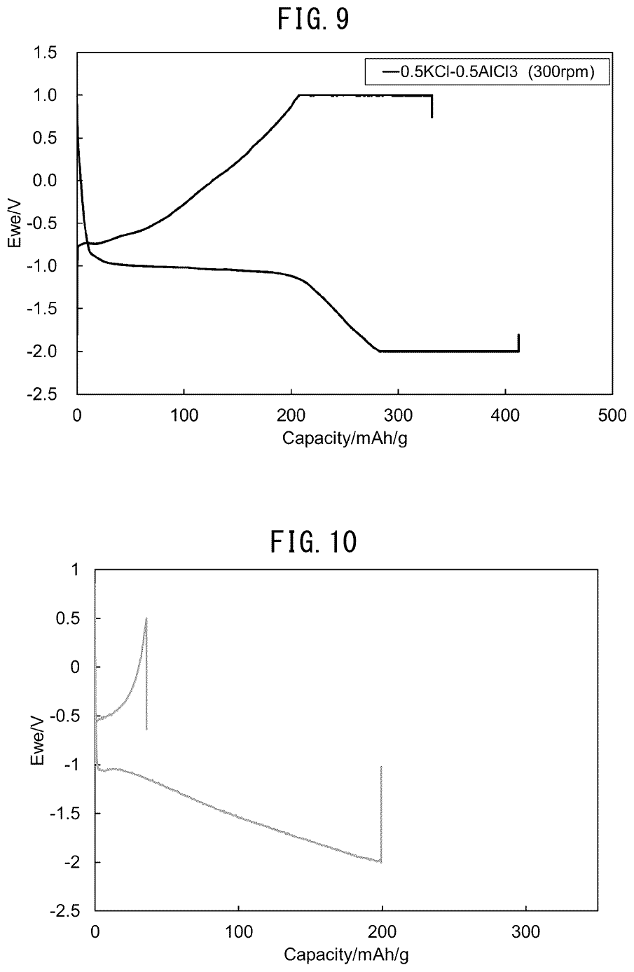

The measured initial charge capacity and initial discharge capacity, and the initial charge-discharge efficiency calculated therefrom are shown in Table 1, and the charge-discharge curves are presented in FIGS. 3 to 10.

The “Number of revolutions of ball mill” in Table 1 means the number of revolutions of the ball mill at the time of production of the negative electrode mixture.

TABLE 1

| | | | | Crystal | Charge-discharge test | | | | |
|---|---|---|---|---|---|---|---|---|---|
| | | | Production | phase of | | | Results based on | | |
| | | | conditions | material for | | | initial charge-discharge | | |
| | Raw materials | | Number of | negative | End-of- | | | | Charge- |
| | Type of | Molar | revolutions | electrode | discharge | Charge- | Charge | Discharge | discharge |
| | alkali | ratio | of ball mill | active | voltage | discharge | capacity | capacity | efficiency |
| | metal (M) | MCl:AlCl₃ | [rpm] | material | [V] | system | [mAh/g] | [mAh/g] | [%] |
| Example 1 | Na | 0.20:0.80 | 600 | NaAlCl₄, AlCl₃ | 0 | CC | 302 | 109 | 36.1 |
| Example 2 | Na | 0.37:0.63 | 600 | NaAlCl₄, AlCl₃ | 0 | CC | 175 | 114 | 65.1 |
| Example 3 | Na | 0.50:0.50 | 600 | NaACl₄ | 0 | CC | 145 | 102 | 70.3 |
| Example 4 | Na | 0.75:0.25 | 600 | NaAlCl₄, NaCl | 0 | CC | 145 | 111 | 76.6 |
| Example 5 | Na | 0.50:0.50 | 300 | NaAlCl₄ | 1.0 | CC | 251 | 193 | 76.9 |
| Example 6 | Li | 0.50:0.50 | 300 | LiAlCl₄ | 1.0 | CCCV | 173 | 159 | 91.9 |
| Example 7 | K | 0.50:0.50 | 300 | KAlCl₄ | 1.0 | CCCV | 411 | 330 | 80.2 |
| Reference | — | 0.00:1.00 | — | AlCl₃ | 0.5 | CCCV | 200 | 35 | 17.5 |
| Example | | | | | | | | | |

As can be seen from Table 1 and FIGS. 3 to 10, the batteries of examples had high initial charge-discharge efficiency. In addition, the initial charge-discharge efficiency of the batteries was further improved by optimization of the type of the raw materials and molar ratio between them, production conditions, and charge-discharge conditions.

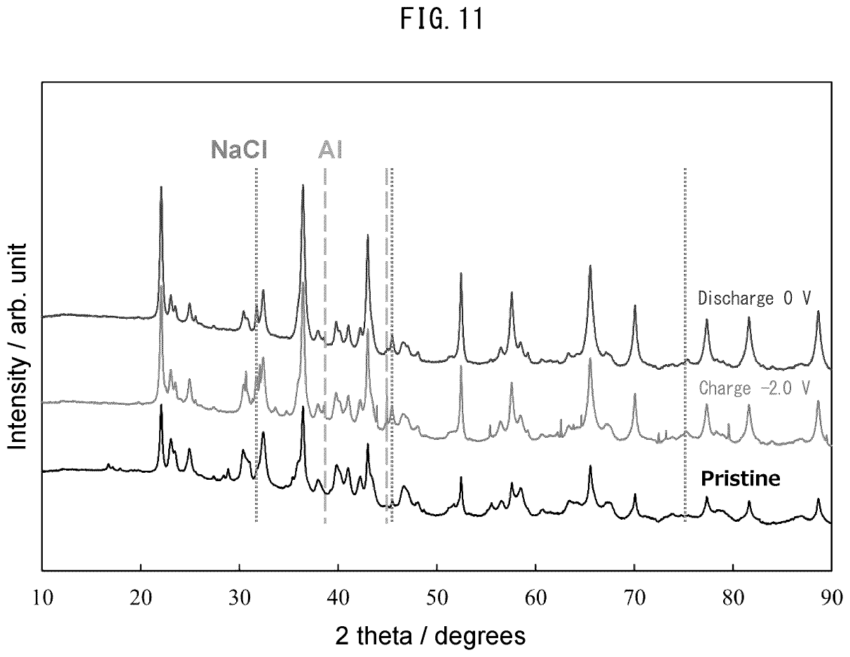

FIG. 11 presents XRD patterns of the material for a negative electrode active material of Example 5 at the initial stage (before charging and discharging), after charging (−2.0 V), and after discharging (0 V). As can be seen from FIG. 11, it was confirmed that NaAlCl₄ was dechlorinated by charging to produce NaCl and Al. It was also confirmed that the peak intensities of NaCl and Al were decreased by discharging, i.e., chlorination proceeded.

### REFERENCE SIGNS LIST

1 Chloride Ion battery
10 Negative electrode current collector layer
20 Negative electrode active material layer
30 Electrolyte layer
40 Positive electrode active material layer
50 Positive electrode current collector layer

1. A negative electrode active material for a chloride ion battery, the negative electrode active material containing a chloroaluminate of an alkali metal.

2. The negative electrode active material for a chloride ion battery according to claim 1,
wherein the alkali metal is sodium, potassium, or lithium, and
wherein the chloroaluminate is a tetrachloroaluminate.

3. A chloride ion battery, including a negative electrode active material layer, wherein
the negative electrode active material layer contains the negative electrode active material for a chloride ion battery according to claim 1.

4. A method for producing the negative electrode active material for a chloride ion battery according to claim 1, the method including treating an alkali metal chloride and aluminum chloride by a mechanical milling method.

5. The method according to claim 4, wherein a molar ratio of the alkali metal chloride to the aluminum chloride is from 0.20:0.80 to 0.80:0.20.
